(19) United States
(12) Patent Application Publication
(10) Pub. No.: US 2025/0375859 A1
(43) Pub. Date: Dec. 11, 2025

(54) NUT SOCKET TOOL, SYSTEM AND METHOD

(71) Applicant: BUILT UP, LLC, MOORE, OK (US)

(72) Inventor: Brent Glover, Moore, OK (US)

(21) Appl. No.: 18/737,341

(22) Filed: Jun. 7, 2024

(51) Int. Cl. B25B 23/12; B25B 13/06; B25B 23/00

(52) U.S. Cl. CPC B25B 23/12; B25B 13/06; B25B 23/0035

(57) ABSTRACT

A tool, system and method for selectively attaching and detaching a loose nut and washer to a fastener is disclosed. The tool, system and method generally include a socket member and a handle member that are selectively detachably connected to one another. The socket member and the handle member each have one or more internal chambers and one or more magnets oriented and positioned for selectively attaching and detaching a metal nut and washer to a fastener and for selectively attaching and detaching the socket member to the handle member. The tool, system and method is configured to be used by utility line workers at height while wearing protective gloves to safely and securely selectively attach and detach loose nuts and washers to fasteners associated with utility line cross arm assemblies.

### FIELD OF INVENTION

The invention is in the technical field of nut socket tools, systems, methods, and kits configured for selectively attaching and detaching a loose nut and washer to a fastener. In particular, the invention is configured to selectively attach and detach loose nuts and washers to fasteners associated with utility line cross arm assemblies and is configured to be used by utility line workers at height and while wearing protective gloves.

### BACKGROUND

Traditional socket and ratchet tools are known in the art and are used in a variety of fields and for a variety of purposes. Traditional socket and ratchet tools often include one or more socket for receiving a nut configured in a variety of different sizes and shapes and one or more socket wrench or ratchet for detachably connecting to the one or more socket for turning the socket about the nut to loosen or tighten the nut on the fastener. Traditional socket wrench or ratchet tools may be manually operated or automatic and may include a reversible ratcheting mechanism which allows a user to pivot the tool back and forth to turn the socket instead of removing and repositioning the wrench or ratchet to do so. Traditional sockets are often configured to be hexagonal or square in shape so that when the socket is turned by the socket wrench or ratchet, the square or hexagonal nut is gripped by the walls of the hexagonal or square interior chamber of the socket to loosen or tighten the nut onto the fastener. Traditional socket and ratchet tools may also be sold as a kit with a variety of different sized or shaped sockets and torque wrenches to tighten or loosen a variety of different sized or shaped nuts.

Unfortunately, however, such traditional socket and ratchet tools, systems and methods are not configured to be used to safely and securely attach or detach a loose nut and washer to a fastener either before or after a separate ratchet or torque tool is used. Traditional socket and ratchet tools are not configured to be used by utility line workers at height while wearing protective gloves to attach or detach a loose nut and washer to a fastener of a utility line cross arm assembly, bracket, or other bracing structure. Installation and repair of utility lines is difficult and dangerous work and often requires specialized tools and equipment. Rain, wind, ice, snow, and other environmental conditions can cause damage to above ground utility lines and distribution systems, including electrical utility lines supported by cross arm assemblies, brackets, and bracing structures. Utility lines including cross arm assemblies, brackets, and bracing structures associated therewith are positioned high above the ground and installation, replacement and repair of such systems is difficult and dangerous work. Sometimes, significant structural damage may occur, including complete or partial breakage of the utility line and cross arm assembly, causing power outages, fire, and other safety hazards to humans and significant damage to property. Utility line workers are often called upon to install, replace or repair such utility lines regardless of weather conditions and often at night or during environmental conditions that are not ideal for performing such work.

Attaching and detaching a loose nut and washer to a fastener at height by a utility line worker is traditionally done by hand while wearing protective gloves designed to protect the utility line worker from electrical shock. Traditionally, to attach a loose nut and washer to a fastener the utility line worker must identify the correct size nut and washer and place, by hand, the correct size nut and washer over the fastener while wearing protective gloves. A traditional socket and ratchet tool is then used to tighten the nut on the fastener. Likewise, to remove a nut and washer from a fastener, a traditional socket and ratchet tool is first used to loosen the nut and then the nut and washer is pulled off the fastener, manually by hand, by the utility line worker while wearing protective gloves. Placement of the loose nut and washer on the fastener and removal of the loose nut and washer from the fastener, by hand, while wearing protective gloves, is extremely difficult, time consuming, and there is a significant risk that the utility line worker may drop the nut and washer before it is secured to the fastener or while removing the nut and washer from the fastener.

Further, the fastener itself that is associated with traditional bracing structures for cross arm assemblies is typically in a horizontal position in relation to the utility line worker making attachment and detachment of a loose nut and washer to the fastener more difficult and increasing the risk that it may drop if not properly held tight by hand when placed on or removed from the fastener. As a result, utility line workers are often tempted to remove their protective gloves to attach or detach a loose nut or washer to a fastener, exposing themselves to danger and potential electrical shock. Thus, increasing the danger and risk of potential harm to utility line workers and increasing the time and expense it takes to properly install or repair such utility line structures when the worker does use protective gloves to attach and detach the loose nut and washer.

For example, while a utility line worker is trying to hang a cut-out with just the use of primary protective gloves, the worker will often drop the nut and washer to the ground, which is often a distance of approximately forty (40) feet and because the user is relying upon the tip of the leather protectors to place the washer and nut. In many instances, the utility line worker may lose the vital equipment to secure the nut and washer properly to the cross arm because such equipment is dropped. To properly attach and detach a loose nut and washer, the user must hold the nut one-handed and pin it on the fastener at the same time. Many times, the nut falls, or it takes several tries to get the threads on the nut to set on the fastener or bolt. When the weather conditions are hot, cold, windy, icy, or light is limited, this process becomes even more difficult and increases the danger and burden on the utility line worker. Other problems associated with this process include getting the lock and washer off the fastener or stud bolt on the L bracket of a cut-out bracket associated with a cross arm assembly. Typically, there are only two ways to remove the lock washer off the stud bolt on the L bracket, and that is by using a flat head screwdriver or channel locks to remove it, which is also a hassle, inconvenient, cumbersome, and slow for a user wearing primary gloves.

To that end, it would be advantageous to provide an improved tool, system, method, and kit that is configured to permit a utility line worker wearing protective gloves and while at height under difficult environmental and lighting conditions, to safely and securely attach and detach a loose nut and washer from a fastener associated with a bracing structure for a cross arm assembly associated with a utility line. The disclosed and claimed invention speeds up the process of installing cut outs and making repairs and replacements to cross arm assemblies and brackets. Further, the disclosed and claimed invention improves safety to the worker by reducing hand cramps associated with traditional tools, systems, and methods. The disclosed and claimed invention is large, easy to use, and comfortable for a user to hold and use, yet it is configured to be light weight, easy to manage, and easy to modify for use with a variety of different sized and shaped nuts, washers, and fasteners. By increasing the safety of the repair and installation process and by increasing the speed and efficiency by which the work is performed the improved nut socket tool, system and method provides numerous non-obvious advantages over traditional tools, systems, and methods. It is to such an improved nut socket tool, system, method, and kit that the disclosed and claimed invention is directed.

### SUMMARY OF THE INVENTION

The inventive concepts disclosed and claimed herein generally relate to a tool, system, method, and kit configured for selectively attaching and detaching a loose nut and washer to and from a fastener. In general, the tool includes a socket member having a plurality of magnetized internal chambers for selectively receiving and connecting to a nut and washer and a handle member detachably connected to the socket member. The handle member includes a knob member for detachably connecting to the socket member and a magnetized internal chamber for selectively receiving a fastener and nut therein. The magnetized internal chamber of the handle member further includes an outer edge around the magnetized internal chamber. The outer edge including a plurality of raised magnets for detachably connecting to the washer that is connected to the fastener when the handle member is placed over the fastener and the washer, such that the handle member is configured to pull up and off the washer from the fastener by the plurality of raised magnets.

In some embodiments, the inventive concepts disclosed and claimed herein include a system for selectively attaching and detaching a nut and washer to a fastener. The system generally includes a socket member having a first end, a second end, and a housing therebetween. The first end of the socket member having a first opening leading into a first internal chamber within the housing. The second end of the socket member having a second opening leading into a second internal chamber within the housing. The first internal chamber has a first magnet positioned at a closed end of the first internal chamber. The second internal chamber having a second magnet positioned at a closed end of the second internal chamber. The second end of the socket member further includes a plurality of magnets embedded within an outer edge of the housing of the second end and positioned around the second opening leading into the second chamber of the socket member.

The system further includes a handle member detachably connected to the socket member. The handle member includes a first end, a second end, and a housing therebetween. The first end of the handle member having an opening leading into an internal chamber within the housing. The second end of the handle member further includes a knob member that protrudes out from the second end. The knob member for detachably connecting the handle member to the socket member wherein the knob member is inserted into the first internal chamber of the socket member to detachably connect the handle member to the socket member. The first end of the handle member further includes a plurality of raised magnets that protrude out from an outer edge of the housing of the first end around the opening leading into the internal chamber of the handle member.

In some embodiments, the knob member is substantially square in shape while in other embodiments, the knob member is substantially circular in shape. Further, in some embodiments, the housing of the handle member has a knurled portion on the outside of the housing for efficiently gripping the handle member by hand and by a user wearing gloves. In some embodiments, the internal chamber of the handle member is substantially square shaped while in other embodiments the internal chamber of the handle member is substantially hexagonal in shape. Likewise, the first internal chamber and the second internal chamber of the socket member may each be substantially square, hexagonal, or circular in shape.

A method of removing a washer from a fastener using the tool and system disclosed herein is also disclosed. The method includes the steps of: (a) selecting from a plurality of different sized and shaped socket members, a socket member having a first end, a second end, and a housing therebetween. The first end of the socket member having a first opening leading into a first internal chamber within the housing. The second end of the socket member having a second opening leading into a second internal chamber within the housing. The first internal chamber has a first magnet positioned at a closed end of the first internal chamber. The second internal chamber having a second magnet positioned at a closed end of the second internal chamber. The second end of the socket member further includes a plurality of magnets embedded within an outer edge of the housing of the second end and positioned around the second opening leading into the second chamber of the socket member.

The method further includes the step of: (b) selecting from a plurality of different sized and shaped handle members, a handle member including a first end, a second end, and a housing therebetween. The first end of the handle member having an opening leading into an internal chamber within the housing. The second end of the handle member includes a knob member that protrudes out from the second end. The knob member for detachably connecting the handle member to the socket member wherein the knob member is inserted into the first internal chamber of the socket member to detachably connect the handle member to the socket member. The first end of the handle member further includes a plurality of raised magnets that protrude out from an outer edge of the housing of the first end around the opening leading into the internal chamber of the handle member. The method further includes the step of: (c) connecting the socket member to the handle member by inserting the knob member into the first internal chamber of the socket member to detachably connect the handle member to the socket member.

The method further includes the step of: (d) connecting the handle member to a washer connected to a fastener by placing the handle member over the fastener such that the fastener is inserted into the internal chamber of the handle member and the plurality of raised magnets positioned around the outer edge of the first end of the housing of the handle member connected to the washer. The method further includes the step of: (e) pulling the washer off the fastener by pulling the handle member off the fastener such that the plurality of raised magnets positioned around the outer edge of the first end of the housing to lift the washer off the fastener. The method further includes the step of: (f) removing the washer from the plurality of raised magnets positioned around the outer edge of the first end of the housing by pushing the washer off the plurality of raised magnets.

In some embodiments, the tool, system and method are configured to hold a square nut, including a 9/16th or a 3/4th nut and the washer with interchangeable socket members. The handle member of the tool, system and method has a strong magnet positioned on top without a locking pin. Instead, the strong magnets hold the socket member to the handle member. Each socket member has one or more magnets located in the bottom of the socket hole which allows the nut to set in place and keeps the nut from falling out. The socket member also includes one or more magnets on top to hold the washer in place and when installing cut-out brackets on a cross arm assembly associated with a utility line.

When a user installs the washer and nut, after the user threads the nut on the fastener along with the washer in place, the user pulls the tool, system and method off the fastener which allows the nut to knock off the washer onto the fastener such as a bolt for example. The tool, system and method are also configured to capture the lock nut located on the fastener or stud bolt that is on the L bracket of the cut-out bracket associated with the cross-arm assembly. A user uses the magnets located on the bottom of the handle member and the internal chamber to slide over the fastener or stud bolt. These magnets capture the lock nut in place so that a user can easily slide the lock nut off the fastener or stud bolt which allows the user to safely grab it off the handle member without dropping it to the ground. The lock washer is significantly easier to remove with this tool, system and method and provides substantial non-obvious benefits over traditional nut and socket tools. Traditional socket and ratchet tools are not suitable for this application.

The improved tool, system and method is configured to fit in the primary gloves of a user and includes a knurled texture on the outside which helps increase the grip while in primary gloves. The improved tool, system and method provides significant safety advantages over traditional tools and speeds up the process of installing the components of a cross arm and related parts and prevents users from cramping up their hands while wearing primary gloves. The improved tool, system and method is not a torquing device. The improved tool, system and method is used to apply the nuts and washers and to help remove the lock washer. The improved tool, system and method may be used in a variety of settings, including to remove lock nuts on various brackets and component parts. It is to such an improved system, tool, and to methods of using thereof that exemplary embodiments of the inventive concepts disclosed and claimed herein are directed.

### BRIEF DESCRIPTION OF THE SEVERAL VIEWS OF THE DRAWINGS

Like reference numerals in the figures represent and refer to the same or similar element or function. Implementations of the disclosure may be better understood when consideration is given to the following detailed description thereof. Such description makes reference to the annexed pictorial illustrations, schematics, graphs, drawings, and appendices. In the drawings:

FIG. 1 is a perspective view of an embodiment of the tool (100) according to the inventive concepts disclosed herein.

FIG. 2 is a perspective view of an embodiment of the system (200) according to the inventive concepts disclosed herein.

FIG. 3 is a perspective view of an embodiment of a system (200) according to the inventive concepts disclosed herein.

FIG. 4 is a diagram of an embodiment of a method (300) according to the inventive concepts disclosed herein.

FIG. 5 is a perspective view of an embodiment of a socket member (105) of the system (200) according to the inventive concepts disclosed herein.

FIG. 6 is a perspective view of an embodiment of a socket member (105) of a system (200) according to the inventive concepts disclosed herein.

FIG. 7 is a perspective view of an embodiment of a system (200) according to the inventive concepts disclosed herein.

FIG. 8 is a perspective view of an embodiment of a system (200) according to the inventive concepts disclosed herein.

FIG. 9 is a perspective view of an embodiment of a system (200) according to the inventive concepts disclosed herein.

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction and the arrangements of the components or steps or methodologies set forth in the following description or illustrated in the drawings. The inventive concepts disclosed herein are capable of other embodiments or of being practiced or carried out in various ways. Also, it is to be understood that the phraseology and terminology employed herein is for the purpose of description and should not be regarded as limiting the inventive concepts claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, well-known features have not been described in detail to avoid unnecessarily complicating the instant disclosure.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

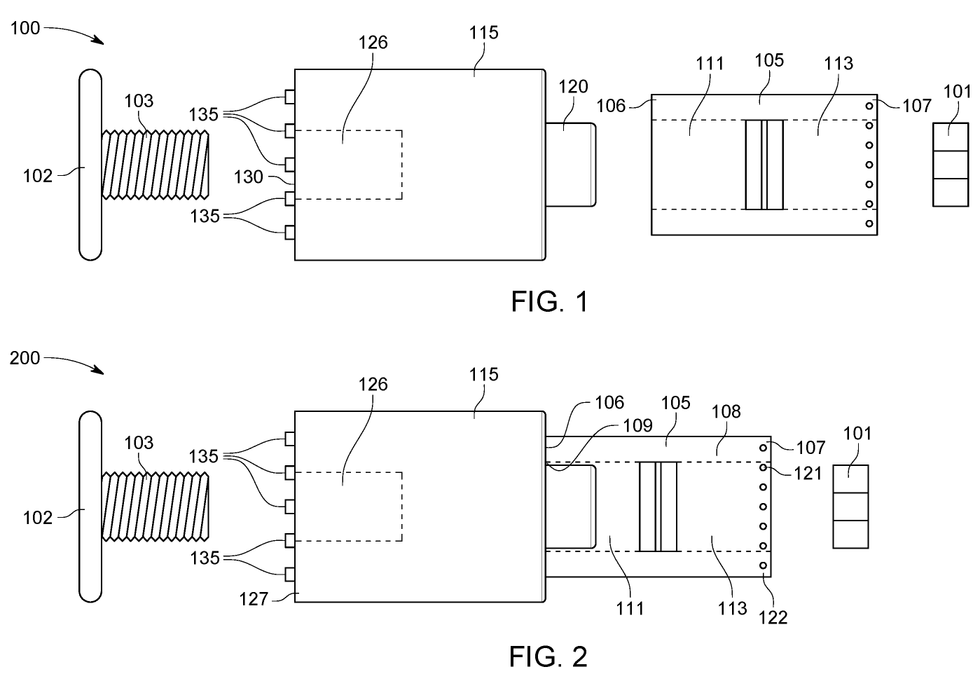

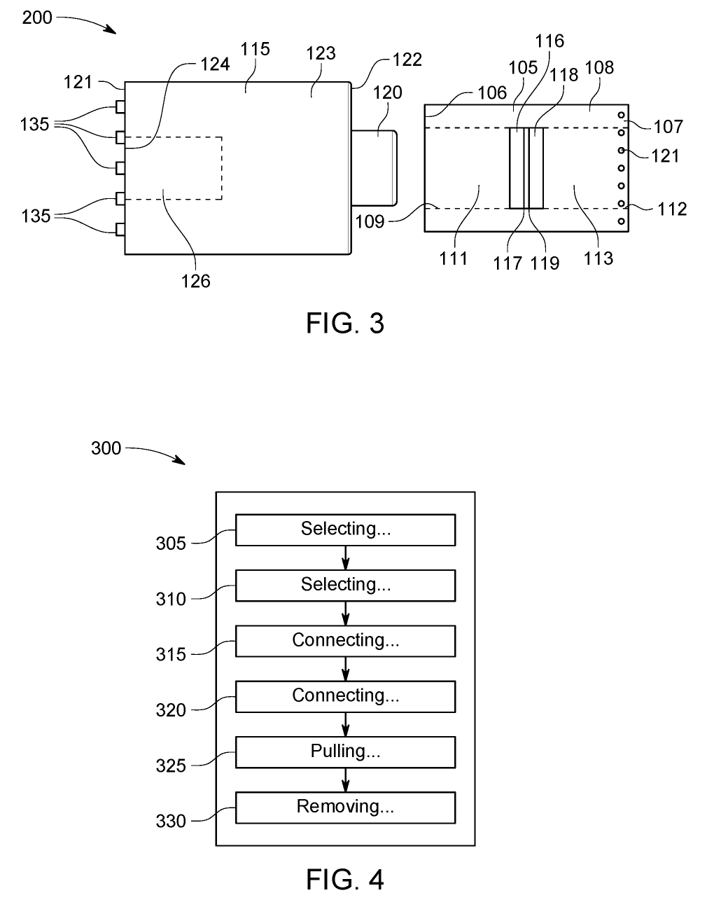

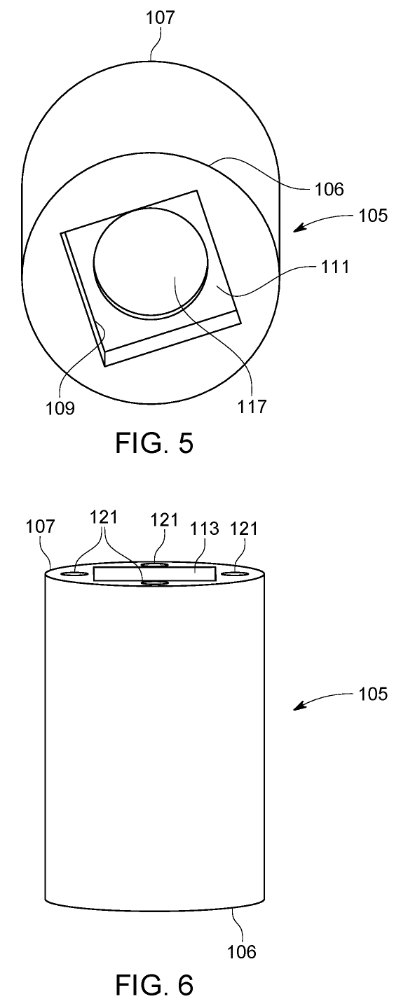

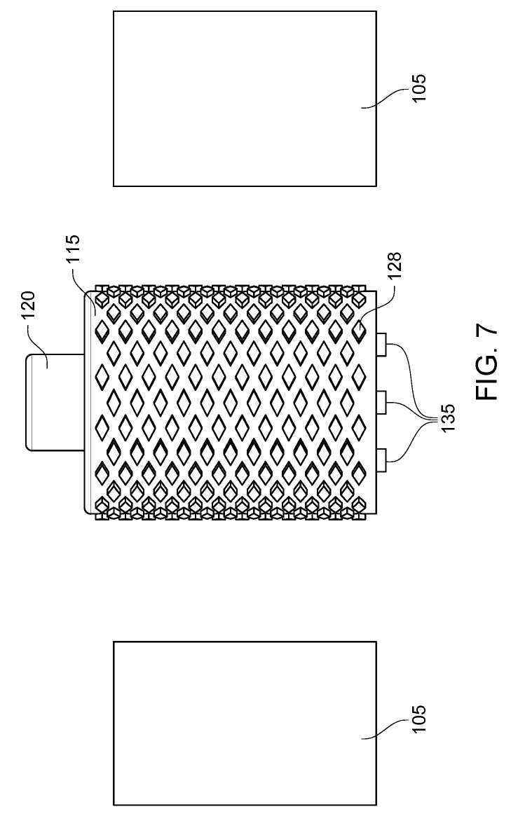

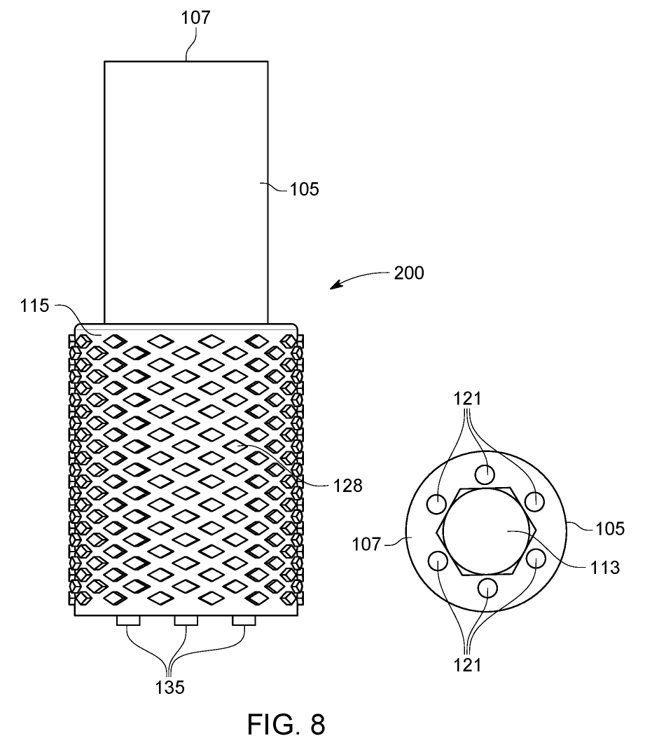

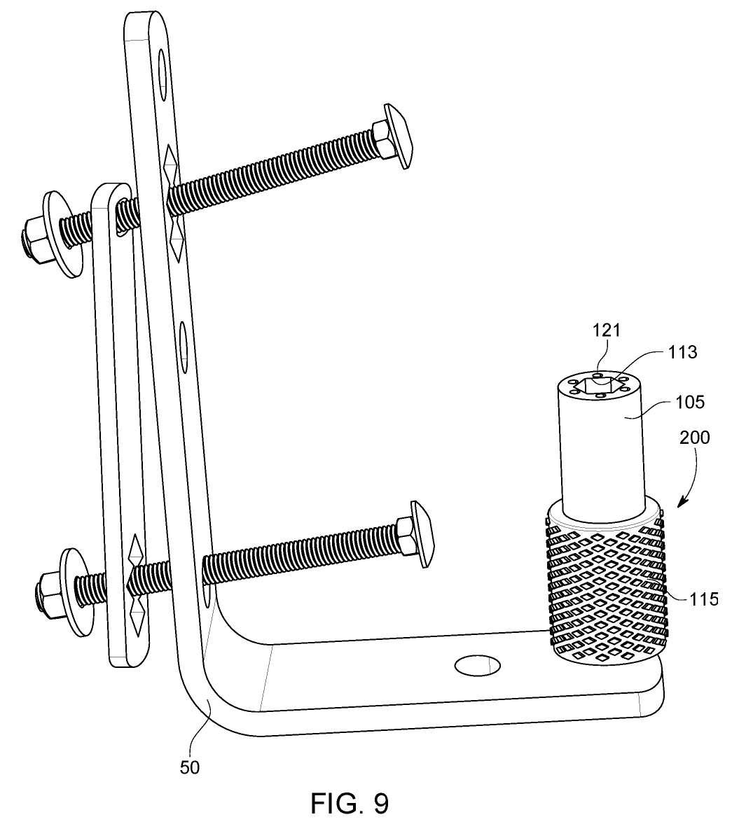

Referring now to FIGS. 1-9, shown therein are perspective views of embodiments of the tool (100), system (200) and method of use (300) in accordance with the inventive concepts disclosed and claimed herein. The tool (100) is for selectively attaching and detaching a nut (101) and washer (102) to a fastener (103). The tool (100) includes a socket member (105) having a plurality of magnetized internal chambers (110) for selectively receiving and connecting to a metal nut (101) and metal washer (102). The tool (100) further includes a handle member (115) detachably connected to the socket member (105). The handle member (115) includes a knob member (120) for detachably connecting to the socket member (105) and a magnetized internal chamber (125) for selectively receiving a metal fastener (103) and metal nut (101) therein. The magnetized internal chamber (125) of the handle member (115) further includes an outer edge (130) around the magnetized internal chamber (125). The outer edge (130) includes a plurality of raised magnets (135) for detachably connecting to the metal washer (102) connected to the metal fastener (103) when the handle member (115) is placed over the metal fastener (103) and metal washer (102), such that the handle member (115) is configured to pull up and off the metal washer (102) from the metal fastener (103) by the plurality of raised magnets (135).

The tool (100), including the socket member (105) and the handle member (115) may be constructed from a variety of different types of materials that are of sufficient structural strength and rigidity necessary to attach and detach a loose nut and washer to and from a fastener and without interfering with the magnets positioned within the tool (100). For example, the tool (100) may be constructed from non-metals, such as plastics, polycarbonate, impact resistant nylon, carbon fiber, polymers, resins, ceramics, or composite materials. Further the tool (100) may be constructed from metals, such as alloys, steel, titanium, combinations thereof and the like. Further, it should be understood that the socket member (105) and the handle member (115) may each be constructed from the same or different materials. For example, in some embodiments, the handle member (115) may be constructed from plastic while the socket member (105) is constructed from metal.

The tool (100), including the socket member (105) and the handle member (115) is shown as having a substantially circular shape. However, it should be understood that the tool (100), including the socket member (105) and the handle member (115) may have any desired shape, including but not limited to, a generally rectangular, square or triangular shape for example. Further, it should be understood that each of the socket member (105) and the handle member (115) may be the same or different shape so long as they are able to be detachably connected to one another and used as described and claimed herein. In some embodiments, the tool (100), including the socket member (105) and the handle member (115) may also include additional ribs, ridges, or bracing structures or components to provide additional strength to the tool (100) so as to prevent deformation, cracking, or bending of the tool (100) when used.

The socket member (105) includes a plurality of magnetized internal chambers (110) for selectively receiving and connecting to a metal nut (101) and metal washer (102). The socket member (105) includes at least one internal chamber (110) for receiving a nut and washer and at least one internal chamber (110) for detachably connecting the socket member (105) to the handle member (115). The plurality of magnetized internal chambers (110) of the socket member (105) are magnetized by one or more magnets that are positioned within the housing of the socket member (105). Some of the one or more magnets are positioned at a bottom closed end of the internal chamber (110) and some are positioned around the opening of the housing leading into the internal chamber (110). The magnetic forces of the magnets detachably connect and secure the metal nut and washer in the internal chamber (110), detachably connect the socket member (105) to the handle member (115), and detachably connect the socket member to a metal bracket or brace surrounding or connected to the fastener during use. For example, the one or more magnets that are positioned around the opening of the internal chamber (110) permit the socket member (105) to be placed flush against a metal bracket or bracing so that the socket member (105) does not accidentally drop to the ground during use if a user lets go of the tool (100). The magnets positioned within the internal chamber (110) permit a user to insert or drop a loose nut and washer directly into the internal chamber (110) of the socket member (105) and then place and position the nut and washer within the internal chamber (110) of the socket member (110) over the fastener to thread the nut and washer onto the fastener by hand by turning the handle member (115) and while the nut and washer are positioned within the internal chamber (110) of the socket member (105). A user may then pull off the socket member (105) by hand or by using the detachably connected handle member (115) leaving the nut and washer threaded onto and detachably connected to the fastener. A user may also let go of the socket member (105) while it is placed flush against a metal bracket during use because the magnets positioned around the opening to the internal chamber (110) detachably connect and secure the tool (100) to the metal bracket or brace. In this way, a user may selectively take his or her hands off the tool during use and without fear that the tool will drop or fall to the ground. A user may then use a traditional torque wrench or ratchet to tighten the nut and washer on the fastener.

The handle member (115) includes a knob member (120) for detachably connecting to the socket member (105) and a magnetized internal chamber (125) for selectively receiving a metal fastener (103) and metal nut (101) therein. The magnetized internal chamber (125) of the handle member (115) further includes an outer edge (130) around the magnetized internal chamber (125). The outer edge (130) includes a plurality of raised magnets (135) for detachably connecting to the metal washer (102) connected to the metal fastener (103) when the handle member (115) is placed over the metal fastener (103) and metal washer (102), such that the handle member (115) is configured to pull up and off the metal washer (102) from the metal fastener (103) by the plurality of raised magnets (135). A user may then use his or her fingers to push the washer off of the raised magnets (135). In this way, it is unlikely that a user will drop the washer when it is pulled off of the fastener because the washer will be detachably connected to the raised magnets (135). Because the raised magnets (135) are raised it is easier and more efficient for a user wearing gloves to use his or her fingers to push the washer off of the raised magnets as opposed to trying to pull or disconnect the washer from a serious of flush magnets. In use, the socket member (105) is primarily used to attach and thread a loose nut and washer onto a fastener; while the handle member (115) is configured primarily to be used to detachably remove a loose nut and washer from a fastener. It should be understood however, that both the handle member (115) and the socket member (105) may be used to both attach and detach a metal nut and washer to a fastener.

The knob member (120) is configured to protrude out from the closed end of the handle member (115) so that it can be inserted into one of the magnetized internal chambers (110) of the socket member (105). The knob member (120) may include one or more magnets within the housing of the knob member so that the knob member (120) is magnetized and may be detachably connected to the socket member (105). The knob member (120) is shown as substantially square or rectangular in shape but may be configured in any shape, including circular, triangular or other shapes so long as the knob member (120) is configured to fit within one of the magnetized internal chambers (110) of the socket member (105) so that the socket member (105) may be detachably connected to the handle member (115).

Referring now to FIGS. 1-9, shown therein is a system (200) for selectively attaching and detaching a nut (101) and washer (102) to a fastener (103). The system (200) includes a socket member (105) having a first end (106), a second end (107), and a housing (108) therebetween. The first end (106) of the socket member (105) having a first opening (109) leading into a first internal chamber (111) within the housing (108). The second end (107) of the socket member (105) having a second opening (112) leading into a second internal chamber (113) within the housing (108). The first internal chamber (111) having a first magnet (116) positioned at a closed end (117) of the first internal chamber (111). The second internal chamber (113) having a second magnet (118) positioned at a closed end (119) of the second internal chamber (113). The second end (107) of the socket member (105) further including a plurality of magnets (121) embedded within an outer edge (122) of the housing (108) of the second end (107) and positioned around the second opening (112) leading into the second chamber (113) of the socket member (105). The system (200) further includes a handle member (115) detachably connected to the socket member (105). The handle member (115) includes a first end (121), a second end (122), and a housing (123) therebetween. The first end (121) of the handle member (115) having an opening (124) leading into an internal chamber (126) within the housing (123), the second end (122) of the handle member (115) further comprising a knob member (120) that protrudes out from the second end (122), the knob member (120) for detachably connecting the handle member (115) to the socket member (105) wherein the knob member (120) is inserted into the first internal chamber (111) of the socket member (105) to detachably connect the handle member (115) to the socket member (105), the first end (121) of the handle member (115) further comprising a plurality of raised magnets (126) that protrude out from an outer edge (127) of the housing (123) of the first end (121) around the opening (124) leading into the internal chamber (126) of the handle member (115).

In some embodiments of the system (200) the knob member (120) is substantially square shaped while in other embodiments the knob member (120) is substantially circular in shape. As described above, it should be understood that the knob member (120) may have any shape, including a square, triangular or rectangular shape provided that it is configured to detachably fit within and connect to the first internal chamber (111) of the socket member (105) so that the socket member (105) may be detachably connected to the handle member (115).

In some embodiments of the system (200) the housing (123) of the handle member (115) further includes a knurled portion (128) for efficiently gripping the handle member (115) by a user wearing gloves. Further, in some embodiments of the system (200) the internal chamber (126) of the handle member (115) is substantially square shaped while in other embodiments, the internal chamber (126) of the handle member (115) is substantially hexagonal in shape. Similarly, in some embodiments of the system (200) the first internal chamber (111) of the socket member (105) is substantially square in shape while in other embodiments the first internal chamber (111) of the socket member (105) is substantially circular in shape. In some embodiments, the second internal chamber (113) of the socket member (105) is substantially square in shape while in other embodiments the second internal chamber (113) of the socket member (105) is substantially hexagonal in shape.

As described above, the system (200), including the socket member (105) and the handle member (115) may be constructed from a variety of different types of materials that are of sufficient structural strength and rigidity necessary to attach and detach a loose nut and washer to and from a fastener and without interfering with the magnets positioned within the system (200). For example, the system (200) may be constructed from non-metals, such as plastics, polycarbonate, impact resistant nylon, carbon fiber, polymers, resins, ceramics, or composite materials. Further the system (200) may be constructed from metals, such as alloys, steel, titanium, combinations thereof and the like. Further, it should be understood that the socket member (105) and the handle member (115) may each be constructed from the same or different materials. For example, in some embodiments, the handle member (115) may be constructed from plastic while the socket member (105) is constructed from metal.

The system (200), including the socket member (105) and the handle member (115) is shown as having a substantially circular shape. However, it should be understood that the system (200), including the socket member (105) and the handle member (115) may have any desired shape, including but not limited to, a generally rectangular, square or triangular shape for example. Further, it should be understood that each of the socket member (105) and the handle member (115) may be the same or different shape so long as they are able to be detachably connected to one another and used as described and claimed herein. In some embodiments, the system (200) including the socket member (105) and the handle member (115) may also include additional ribs, ridges, or bracing structures or components to provide additional strength to the system (200) so as to prevent deformation, cracking, or bending of the system (200) when used.

The socket member (105) includes a first end (106), a second end (107), and a housing (108) therebetween. The first end (106) of the socket member (105) having a first opening (109) leading into a first internal chamber (111) within the housing (108). The second end (107) of the socket member (105) having a second opening (112) leading into a second internal chamber (113) within the housing (108). The first internal chamber (111) having a first magnet (116) positioned at a closed end (117) of the first internal chamber (111). The second internal chamber (113) having a second magnet (118) positioned at a closed end (119) of the second internal chamber (113). The second end (107) of the socket member (105) further including a plurality of magnets (121) embedded within an outer edge (122) of the housing (108) of the second end (107) and positioned around the second opening (112) leading into the second chamber (113) of the socket member (105).

The handle member (115) is configured to be detachably connected to the socket member (105). The handle member (115) includes a first end (121), a second end (122), and a housing (123) therebetween. The first end (121) of the handle member (115) having an opening (124) leading into an internal chamber (126) within the housing (123). The second end (122) of the handle member (115) further includes a knob member (120) that protrudes out from the second end (122). The knob member (120) is for detachably connecting the handle member (115) to the socket member (105). The handle member (115) is detachably connected to the socket member (105) by the knob member (120) when the knob member (120) is inserted into the first internal chamber (111) of the socket member (105) to detachably connect the handle member (115) to the socket member (105). The first end (121) of the handle member (115) further includes a plurality of raised magnets (126) that protrude out from an outer edge (127) of the housing (123) of the first end (121) around the opening (124) leading into the internal chamber (126) of the handle member (115).

Referring now to FIG. 4, a method (300) of removing a washer from a fastener is also disclosed. The method includes the steps of: (a) selecting (305), from a plurality of different sized and shaped socket members (105), a socket member (105) comprising a first end (106), a second end (107), and a housing (108) therebetween. The first end (106) of the socket member (105) having a first opening (109) leading into a first internal chamber (111) within the housing (108). The second end (107) of the socket member (105) having a second opening (112) leading into a second internal chamber (113) within the housing (108). The first internal chamber (111) having a first magnet (116) positioned at a closed end (117) of the first internal chamber (111). The second internal chamber (113) having a second magnet (118) positioned at a closed end (119) of the second internal chamber (113). The second end (107) of the socket member (105) further including a plurality of magnets (121) embedded within an outer edge (122) of the housing (108) of the second end (107) and positioned around the second opening (112) leading into the second chamber (113) of the socket member (105).

The method (300) further includes the step of (b) selecting (310), from a plurality of different sized and shaped handle members (115), a handle member (115) including a first end (121), a second end (122), and a housing (123) therebetween. The first end (121) of the handle member (115) having an opening (124) leading into an internal chamber (126) within the housing (123). The second end (122) of the handle member (115) further including a knob member (120) that protrudes out from the second end (122). The knob member (120) for detachably connecting the handle member (115) to the socket member (105) wherein the knob member (120) is inserted into the first internal chamber (111) of the socket member (105) to detachably connect the handle member (115) to the socket member (105). The first end (121) of the handle member (115) further including a plurality of raised magnets (126) that protrude out from an outer edge (127) of the housing (123) of the first end (121) around the opening (124) leading into the internal chamber (126) of the handle member (115).

The method (300) further includes the step of (c) connecting (315) the socket member (105) to the handle member (115) by inserting the knob member (120) into the first internal chamber (111) of the socket member (105) to detachably connect the handle member (115) to the socket member (105). The method (300) further includes the step of (d) connecting (320) the handle member (115) to a washer (102) connected to a fastener (103) by placing the handle member (115) over the fastener (103) such that the fastener (103) is inserted into the internal chamber (126) of the handle member (115) and the plurality of raised magnets (126) positioned around the outer edge (127) of the first end (121) of the housing (123) of the handle member (115) connected to the washer (102). The method (300) further includes the step of (e) pulling (325) the washer (102) off of the fastener (103) by pulling the handle member (115) off of the fastener (103) such that the plurality of raised magnets (126) positioned around the outer edge (127) of the first end (121) of the housing (123) to lift the washer (102) off of the fastener (103). Further, the method (300) includes the step of (f) removing (330) the washer (102) from the plurality of raised magnets (126) positioned around the outer edge (127) of the first end (121) of the housing (123) by pushing the washer (102) off of the plurality of raised magnets (126).

It is to be appreciated that embodiments of the inventive concepts disclosed herein may be shipped fully or partially assembled, or fully or partially disassembled in the form of a kit, as will be readily appreciated by persons of ordinary skill in the art having the benefit of the instant disclosure.

From the above description, it is clear that the inventive concepts disclosed herein are adapted to carry out the objects and to attain the advantages mentioned herein as well as those inherent in the inventive concepts disclosed herein. While exemplary embodiments of the inventive concepts disclosed herein have been described for purposes of this disclosure, it will be understood that numerous changes may be made which will readily suggest themselves to those skilled in the art and which are accomplished within the broad scope of the inventive concepts disclosed herein and defined by the appended claims.

What is claimed is:

1. A tool for selectively attaching and detaching a nut and washer to a fastener, the tool comprising:
a socket member comprising a plurality of magnetized internal chambers for selectively receiving and connecting to a metal nut and metal washer; and
a handle member detachably connected to the socket member, the handle member comprising a knob member for detachably connecting to the socket member and a magnetized internal chamber for selectively receiving a metal fastener and metal nut therein, the magnetized internal chamber of the handle member further comprising an outer edge around the magnetized internal chamber, the outer edge comprising a plurality of raised magnets for detachably connecting to the metal washer connected to the metal fastener when the handle member is placed over the metal fastener and metal washer, such that the handle member is configured to pull up and off the metal washer from the metal fastener by the plurality of raised magnets.

2. A system for selectively attaching and detaching a nut and washer to a fastener, the system comprising:
a socket member comprising a first end, a second end, and a housing therebetween, the first end of the socket member having a first opening leading into a first internal chamber within the housing, the second end of the socket member having a second opening leading into a second internal chamber within the housing, the first internal chamber having a first magnet positioned at a closed end of the first internal chamber, the second internal chamber having a second magnet positioned at a closed end of the second internal chamber, the second end of the socket member further comprising a plurality of magnets embedded within an outer edge of the housing of the second end and positioned around the second opening leading into the second chamber of the socket member; and
a handle member detachably connected to the socket member, the handle member comprising a first end, a second end, and a housing therebetween, the first end of the handle member having an opening leading into an internal chamber within the housing, the second end of the handle member further comprising a knob member that protrudes out from the second end, the knob member for detachably connecting the handle member to the socket member wherein the knob member is inserted into the first internal chamber of the socket member to detachably connect the handle member to the socket member, the first end of the handle member further comprising a plurality of raised magnets that protrude out from an outer edge of the housing of the first end around the opening leading into the internal chamber of the handle member.

3. The system of claim 2 wherein the knob member is substantially square shaped.

4. The system of claim 2 wherein the knob member is substantially circular in shape.

5. The system of claim 2 wherein the housing of the handle member further comprises a knurled portion for efficiently gripping the handle member by a user wearing gloves.

6. The system of claim 2 wherein the internal chamber of the handle member is substantially square shaped.

7. The system of claim 2 wherein the internal chamber of the handle member is substantially hexagonal in shape.

8. The system of claim 2 wherein the first internal chamber of the socket member is substantially square in shape.

9. The system of claim 2 wherein the first internal chamber of the socket member is substantially circular in shape.

10. The system of claim 2 wherein the second internal chamber of the socket member is substantially square in shape.

11. The system of claim 2 wherein the second internal chamber of the socket member is substantially hexagonal in shape.

12. A method of removing a washer from a fastener, the method comprising the steps of:
selecting, from a plurality of different sized and shaped socket members, a socket member comprising a first end, a second end, and a housing therebetween, the first end of the socket member having a first opening leading into a first internal chamber within the housing, the second end of the socket member having a second opening leading into a second internal chamber within the housing, the first internal chamber having a first magnet positioned at a closed end of the first internal chamber, the second internal chamber having a second magnet positioned at a closed end of the second internal chamber, the second end of the socket member further comprising a plurality of magnets embedded within an outer edge of the housing of the second end and positioned around the second opening leading into the second chamber of the socket member;
selecting, from a plurality of different sized and shaped handle members, a handle member comprising a first end, a second end, and a housing therebetween, the first end of the handle member having an opening leading into an internal chamber within the housing, the second end of the handle member further comprising a knob member that protrudes out from the second end, the knob member for detachably connecting the handle member to the socket member wherein the knob member is inserted into the first internal chamber of the socket member to detachably connect the handle member to the socket member, the first end of the handle member further comprising a plurality of raised magnets that protrude out from an outer edge of the housing of the first end around the opening leading into the internal chamber of the handle member;
connecting the socket member to the handle member by inserting the knob member into the first internal chamber of the socket member to detachably connect the handle member to the socket member;
connecting the handle member to a washer connected to a fastener by placing the handle member over the fastener such that the fastener is inserted into the internal chamber of the handle member and the plurality of raised magnets positioned around the outer edge of the first end of the housing of the handle member connected to the washer;
pulling the washer off of the fastener by pulling the handle member off of the fastener such that the plurality of raised magnets positioned around the outer edge of the first end of the housing to lift the washer off of the fastener; and
removing the washer from the plurality of raised magnets positioned around the outer edge of the first end of the housing by pushing the washer off of the plurality of raised magnets.
